(19) United States
(12) Patent Application Publication
(10) Pub. No.: US 2024/0119366 A1
(43) Pub. Date: Apr. 11, 2024

(54) ONLINE TRAINING OF MACHINE LEARNING MODELS USING BAYESIAN INFERENCE OVER NOISE

(71) Applicant: Google LLC, Mountain View, CA (US)

(72) Inventors: Matthew Jones, Mountain View, CA (US); Michael Curtis Mozer, Mountain View, CA (US)

(21) Appl. No.: 18/477,525

(22) Filed: Sep. 28, 2023

Related U.S. Application Data
(60) Provisional application No. 63/411,102, filed on Sep. 28, 2022.

(51) Int. Cl. G06N 20/00

(52) U.S. Cl. CPC G06N 20/00

(57) ABSTRACT

Methods, systems, and apparatus, including computer programs encoded on a computer storage medium, for online training of machine learning models predicting time-series data. In one aspect, a method comprises training a machine learning model having a plurality of weights by maintaining weight data, specifying a plurality of sub-weights for each of the plurality of weights and covariance data that estimates the joint uncertainty between the sub-weights, and, at each of a plurality of time steps, receiving model inputs, processing the model inputs using the weight data to generate corresponding model outputs, receiving corresponding ground truth outputs, and updating the weight data using the corresponding ground truth outputs.

### CROSS-REFERENCE TO RELATED APPLICATION

This application claims priority to U.S. Provisional Application No. 63/411,102, filed on Sep. 28, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can perform online training of a machine learning model for predicting time-series data.

Particular embodiments of the subject matter described in this specification can be implemented so as to realize one or more of the following advantages.

The described methods are able to perform accurate online learning for a wider range of time-series applications compared to conventional methods for online learning. Unlike conventional online learning methods, which commonly rely on heuristic approaches for adapting to fluctuations in model parameters over time, the described methods can perform exact or approximate Bayesian inference of model parameters for time-series data with an intricate temporal structure, such as fluctuations across multiple time-scales. By representing the model parameters as a combination of multiple separate stochastic processes that can behave differently over distinct time-scales, the described methods can learn the model parameters more accurately when modeling time-series data, even when the data has an intricate temporal structure.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example online learning system.

FIG. 2 shows an example temporal weight update system.

FIG. 3 is a flow diagram of an example process for online model training.

Like reference numbers and designations in the various drawings indicate like elements.

### DETAILED DESCRIPTION

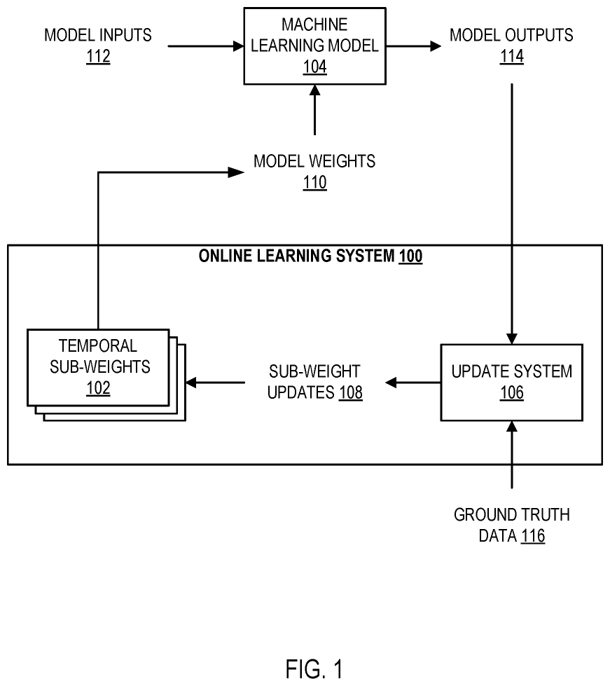

FIG. 1 shows an example online learning system 100. The online learning system 100 is an example of a system implemented as computer programs on one or more computers in one or more locations in which the systems, components, and techniques described below are implemented.

The system 100 operates in conjunction with a machine learning model 104.

The machine learning model is configured to process model inputs 112 in accordance with model weights 110 to produce model outputs 114 that are predictive of ground truth data 116. In other words, the model output 114 for a given model input 112 is a prediction of a corresponding ground truth output for the model input 112 for a machine learning task, i.e., of an actual output that should be generated by performing the machine learning task on the model input 112.

The model inputs 112, model outputs 114, and ground truth data 116 are instances of time-series data. That is, the system 100 receives a respective model input 112 at each of multiple time steps in a sequence of time steps. The system 100 then generates a model output 114 for the model input 112 that was received at the time step and also receives ground truth data 116 for the model input 112.

The system 100 can receive the model inputs 112 and ground truth data 116 by any of a variety of methods. For example, the system 100 can receive model inputs 112 and ground truth data 116 stored in memory. As another example, the system 100 can receive values for the model inputs 112 and the ground truth outputs 116 at each time step from one or more sensors that measure the model inputs 112 and the ground truth outputs 116.

The model 104 can be trained to perform any kind of machine learning task, i.e., can be configured to receive any kind of digital data input 112 and to generate any kind of score, classification, or regression output 114 based on the input 112.

In some cases, the model 104 is a neural network that is configured to perform an image processing task, i.e., receive an image as the model input 112 and to process the intensity values of the pixels of the input image 112 to generate a model output 114 for the input image 112. For example, the task may be image classification and the output 114 generated by the model 104 for the input image 112 may be scores for each of a set of object categories, with each score representing an estimated likelihood that the input image 112 contains an image of an object belonging to the category. As another example, the task can be image embedding generation and the output 114 generated by the model 104 can be a numeric embedding of the input image 112. As yet another example, the task can be object detection and the output 114 generated by the model 104 can identify locations in the input image 112 at which particular types of objects are depicted. As yet another example, the task can be image segmentation and the output 114 generated by the model 104 can assign each pixel of the input image 112 to a category from a set of categories.

As another example, if the inputs 112 to the model 104 are Internet resources (e.g., web pages), documents, or portions of documents or features extracted from Internet resources, documents, or portions of documents, the task can be to classify the resource or document, i.e., the output 114 generated by the model 104 for a given Internet resource, document, or portion of a document may be a score for each of a set of topics, with each score representing an estimated likelihood that the Internet resource, document, or document portion is about the topic.

As another example, if the inputs 112 to the model 104 are features of an impression context for a particular advertisement, the output 114 generated by the model 104 may be a score that represents an estimated likelihood that the particular advertisement will be clicked on.

As another example, if the inputs 112 to the model 104 are features of a personalized recommendation for a user, e.g., features characterizing the context for the recommendation, e.g., features characterizing previous actions taken by the user, the output 114 generated by the model 104 may be a score for each of a set of content items, with each score representing an estimated likelihood that the user will respond favorably to being recommended the content item.

As another example, if the input to the model 104 is a sequence of text in one language, the output 114 generated by the model 104 may be a score for each of a set of pieces of text in another language, with each score representing an estimated likelihood that the piece of text in the other language is a proper translation of the input text into the other language.

As another example, the task may be an audio processing task. For example, if the input 112 to the model 104 is a sequence representing a spoken utterance, the output 114 generated by the model 104 may be a score for each of a set of pieces of text, each score representing an estimated likelihood that the piece of text is the correct transcript for the utterance. As another example, the task may be a keyword spotting task where, if the input 112 to the model 104 is a sequence representing a spoken utterance, the output 114 generated by the model 104 can indicate whether a particular word or phrase (“hotword”) was spoken in the utterance. As another example, if the input 112 to the model 104 is a sequence representing a spoken utterance, the output 114 generated by the model 104 can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input 112 is text in a natural language or features of text in a natural language and the model output 114 is a spectrogram or other data defining audio of the text being spoken in the natural language.

As another example, the task can be a health prediction task, where the input 112 is electronic health record data for a patient and the output 114 is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input 112 is an observation characterizing the state of an environment and the output 114 defines an action to be performed by the agent in response to the observation. The agent can be, e.g., a real-world or simulated robot, a control system for an industrial facility, or a control system that controls a different kind of agent.

As another example, the task can be a content recommendation task, where the input 112 is data characterizing a content recommendation context, i.e. the context in which the recommendation is made and in which the model 104 operates, and the output 114 is one or more scores representing a recommendation of one or more content items. The recommended content items can be any appropriate type of content item, e.g., a video, an electronic book, a software application, a news article, a web page, a music content item, e.g., a song, a web page or other resource describing a product, and so on. For example, the model 104 can generate content recommendations 114 during a conversation between a user and one or more other entities, e.g., another user or a chatbot or both. As another example, the model 104 system can generate content recommendations 114 in response to search queries submitted by a user to a search engine, e.g., an Internet search engine that searches web pages on the Internet, an image search engine that searches a repository of images, a video search engine that searches a repository of videos, an app store search engine that searches a repository of software applications that are available for download, an electronic book store search engine that searches a repository of electronic books, and so on.

As another example, the task can be a hardware fault prediction task, where the input 112 is data characterizing the behavior of a hardware device, e.g., signals measured from the hardware device, and the output 114 is a prediction that is relevant to future failures of the hardware device, e.g., a predicted time until the next failure of the hardware device, a likelihood that the hardware device will encounter a fault in a future time span, or a predicted state of the device.

As another example, the task can be a time-series prediction task, where the input 112 is data characterizing past values of a time-series and the output 114 is a prediction of future values of the time-series. As a further example, the task can be a human activity prediction task, where the time-series of data characterizing a user's exercise activity over time as collected by a wearable device and the output 114 predicts future exercise activities. As a further example, the task can be a location prediction task, where the time-series of data characterizing a user's location over time as collected by a device, such as a phone, and the output 114 predicts future locations.

Generally, the model 104 can be any type of parameterized machine learning model, e.g., a linear model, a perceptron with a non-linear activation function, or a neural network with multiple layers of non-linearities.

This specification generally describes the system 100 as performing online training of the machine learning model 104 to perform a machine learning task. The training is referred to as “online” training because the system 100 can update the model weights 110 after one or more time steps for which the model is used to make output predictions 114.

After the model 104 generates a model output 114, the system receives ground truth data 116 and the system uses the model output 114 and ground truth data 116 to update the model weights 110 and train the model 104.

The ground truth data 116 corresponds to the model inputs 112 and provides a corresponding example of what model output 114 the model 104 should produce when processing the model input 112.

During training, the system 100 processes the model output 114 and the corresponding ground truth data 116 based on an objective function appropriate for measuring how closely the model output 114 replicates the corresponding ground truth data 116 for the purposes of the task performed by the model 104. For example, if the model 104 performs a regression task, the objective function can be L2 loss. As another example, if the model 104 performs a classification task, the objective function can be cross-entropy loss.

The system 100 can update model weight updates 110 to perform online training of the model 104. To perform online training of the model 104 using time-series model inputs 112 and ground-truth data 116, the system 100 obtains a prediction from the model 104 for each of one or more time-steps within the time-series inputs 112 and ground truth data 116. The system 100 compares the one or more model outputs 114 to the corresponding ground truth data using the appropriate objective function for the machine learning task. The system 100 then updates the model weights 110 such that the model 104 processes subsequent inputs 112 to produce predictive model outputs 114 at future time steps. The outputs 114 are referred to as “predictive” because the outputs can closely replicate corresponding ground truth data 116 as measured by the appropriate objective function for the machine learning task.

If the model inputs 112 or the ground truth data 116 are time-series data with intricate temporal structures, the model 104 can require different model weights 110 at different times to produce predictive outputs 114. For example, the model 104 can require time-varying model weights 110 in certain meteorological prediction tasks modeling systems affected by climate change. For example, the model inputs 112 or the ground truth data 116 can be stochastic processes that fluctuate across multiple time scales and the model 104 can require different model weights 110 at different times in a variety of real-word tasks. For example, the model inputs 112 and the ground truth data 116 can fluctuate over different time scales in certain meteorological prediction tasks, where the model inputs 112 and ground truth data are meteorological data. As another example, the model inputs 112 and the ground truth data can fluctuate over different time scales in machine learning tasks for predicting the state or properties of electronic hardware, where the model inputs 112 and the ground truth data 116 characterize the behavior (e.g. signals measured from the hardware) or the properties (e.g., resistance, conductivity, failure probability) of electronic hardware. As a further example, the model inputs 112 or the ground truth data 116 can be instances of 1/f noise.

To usefully update the model weights 110 at different times, the system 100 performs Bayesian inference characterizing the model weights 110 as a time-varying stochastic process. In particular, the system 100 performs Bayesian inference characterizing the model weights 110 as a combination of multiple time-varying stochastic sub-processes, with each sub-process characterized by one of a set of temporal sub-weights 102. The system 100 characterizes the model weights 110 as a combination of the set of temporal sub-weights 102 and performs Bayesian inference of the temporal sub-weights 102 that characterizes each of the temporal sub-weights 102 as time-varying stochastic processes. The system 100 stores the temporal sub-weights 102. In some implementations, each of the temporal sub-weights 102 can correspond to exactly one of the model weights 110.

The system 100 can characterize the temporal sub-weights 102 as stochastic processes with different time dependencies, enabling the system 100 to characterize the model weights 110 as a stochastic process that fluctuates appropriately across multiple timescales.

In some implementations, the system 100 stores multiple sets of temporal sub-weights 102 and combines the sets of sub-weights 102 by summation. Representing the model weights 110 at time t as the stochastic variable \vec{θ}ₜ and the i-th set of temporal sub-weights 102 as the stochastic variable \vec{z}_{i,t}, some implementations therefore determine the model weights 110 by performing the summation:

$${\vec{θ}}_{t} = {\sum }_{i = 1}^{k} {\vec{z}}_{i , t}$$

In some implementations, the system 100 characterizes the temporal sub-weights 102 as Ornstein-Uhlenbeck processes. In some implementations, the system 100 characterizes the temporal sub-weights 102 as particularly specialized Ornstein-Uhlenbeck processes that, for a chosen γ>1 and with \vec{W}ᵢ denoting a standard multi-dimensional Wiener process (Brownian motion), satisfy the equation:

$$d {\vec{z}}_{i , t} = - {γ}^{i} {\vec{z}}_{i , t} dt + {γ}^{- \frac{i}{2}} d \vec{{W}_{i}}$$

In some implementations, the system 100 characterizes the temporal sub-weights 102 as the above specialized Ornstein-Uhlenbeck processes and determines the model weights 110 by summation of the temporal sub-weights 102, and the system 100 is said to characterize the model weights 110 as 1/f noise.

The system 100 includes an update system 106 to update the temporal sub-weights 102 in accordance with the performed Bayesian inference. The update system 106 can process the model outputs 114 and ground truth data 116 from one or more time steps to generate sub-weight updates 108. The system 100 can apply these sub-weight updates 108 to the collection of temporal sub-weights 102.

The system 100 combines the sets of temporal sub-weights 102 to produce the model weights 110.

The machine learning model 104 uses the resulting model weights 110 to produce the model outputs 114 for one or more time steps. The system 100 processes the model outputs 114 and the corresponding ground truth data 116 for the same time steps to update the temporal sub-weights 102.

The system 100 uses the newly updated temporal sub-weights 102 during later time-steps. By updating the temporal sub-weights 102 in this manner, the model 104 can use the resulting model weights 110 to make accurate predictions, even when the model inputs 112 and the ground truth data 116 are time-series that fluctuate over multiple time-scales.

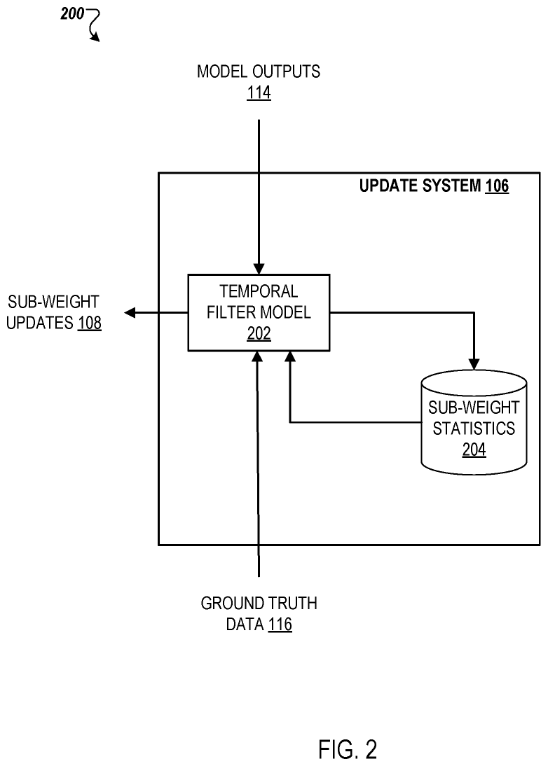

FIG. 2 shows an example temporal weight update system 106. The temporal weight update system 106 is an example of a system implemented as computer programs on one or more computers in one or more locations in which the systems, components, and techniques described below are implemented.

The temporal weight update system 106 includes a temporal filter model 202 and stores sub-weight statistics 204. The sub-weight statistics 204 include covariance data estimating joint uncertainty between the temporal sub-weights.

The temporal filter model 202 performs the computation required for Bayesian inference of the temporal sub-weights 102 as stochastic processes. The temporal filter model 202 is configured to process the model outputs 114, ground truth data 116, and stored sub-weight statistics 204 to generate the sub-weight updates 108 and to update the stored sub-weight statistics 204.

The temporal filter model 202 can be chosen to perform exact Bayesian inference of the model weights 110, based on properties of the machine learning model 104 and based on how the system 100 characterizes the model weights 110.

As an example, in implementations where the machine learning model 104 is a linear model, predicting scalar output yₜ based on inputs \vec{x}ₜ and model weights \vec{θ}ₜ, and where the system 100 characterizes the model weights 110 and the temporal sub-weights 102 as forming a linear dynamic system, the temporal filter model 202 can be a Kalman Filter that can perform online exact Bayesian inference. In this linear example, the linear machine learning model 104 predicts scalar output yₜ based on n dimensional inputs \vec{x}ₜ and model weights \vec{θ}ₜ, and the Kalman Filter performs exact Bayesian inference over k sets of temporal sub-weights, characterizing the temporal sub-weights 102 as having a Gaussian distribution with mean \vec{μ}ₜ and covariance Σₜ. In this linear example, the Kalman Filter characterizes the temporal sub-weights 102 as being distributed according to the equation:

\vec{Z}ₜ|\vec{x}_{<t},y_{<t}˜ [symbol] (μₜ,Σₜ)

Where \vec{Z}ₜ is an nk dimensional vector representing every temporal sub-weight. The notation [ij] will be used throughout to denote a combined index denoting a model weight index, j, and a temporal sub-weight set index, i. One such combined index can be computed following:

[ij]=ni+j

Using this common index, \vec{Z}ₜ can be defined via the relation:

Z_{t,[ij]}=z_{i,t,j}

A multiplexed copy of the inputs, \vec{X}ₜ, can be defined via the relation:

\vec{X}_{t,[ij]}=\vec{x}_{t,j}

An nk×nk projection matrix P_{X,t} orthogonal to the multiplexed inputs, \vec{X}ₜ, can be defined via the relation:

$${P}_{X , t} = I - \frac{{\vec{X}}_{t} {\vec{X}}_{t}^{T}}{{\vec{X}}_{t}^{T} {\vec{X}}_{t}}$$

A diagonal nk×nk decay factor matrix D can be defined via the relation:

$${D}_{[ i j ] , [ i j ]} = {e}^{- \frac{1}{{τ}_{i}}}$$

A diagonal nk×nk noise accumulation matrix N can be defined via the relation:

$${N}_{[ i j ] , [ i j ]} = 2 {ρ}^{2} ( 1 - {e}^{- \frac{2}{{τ}_{i}}} )$$

In this linear example, exact Bayesian inference following the Kalman Filter predicts yₜ by performing the computation:

ŷₜ=\vec{X}ₜ^{T}\vec{μ}ₜ

The linear Kalman Filter performs the updates:

$${\vec{μ}}_{t + 1} = D ( {\vec{μ}}_{t} + \frac{{\sum }_{t} \vec{{X}_{t}}}{{\vec{X}}_{t}^{T} {\sum }_{t} {\vec{X}}_{t}} ( {y}_{t} - {\hat{y}}_{t} ) )$$

$${\sum }_{t + 1} = D {( {P}_{X , t} {\sum }_{t}^{- 1} {P}_{X , t} + \vec{{X}_{t}} {\vec{X}}_{t}^{T} )}^{- 1} {P}_{X , t} D + N$$

In this example, the system 100 stores the updated \vec{μ}ₜ₊₁ (i.e., the mean of the distribution characterizing the temporal sub-weights) as the current temporal sub-weights 102 and the updated Σₜ₊₁ (i.e., the covariance of the distribution characterizing the temporal sub-weights, estimating a joint uncertainty between the temporal sub-weights) as the current sub-weight statistics 204.

The temporal filter model 202 can also be chosen to perform approximate Bayesian inference of the model weights 110. As an example, in implementations where the machine learning model 104 is a non-linear model and where the system 100 characterizes the model weights 110 and the temporal sub-weights 102 as forming a linear dynamic system, the temporal filter model 202 can be an Extended Kalman Filter to perform approximate Bayesian inference. An Extended Kalman Filter involves linearizing the non-linear machine learning model 104 by employing a local linear approximation based on a Jacobian of the non-linear model 104.

In this non-linear example, the non-linear model 104 produces an output ŷₜ that predicts an l-dimensional vector of sufficient statistics regarding the ground truth data, \vec{T}_{y,t}. In a classification task, this output ŷₜ can be a vector of predicted class probabilities while the sufficient statistics, \vec{T}_{y,t}, can be a one-hot vector encoding the ground truth class. The non-linear model can perform the computation:

\vec{y}ₜ=f(\vec{x}ₜ,\vec{μ}ₜ)

In this non-linear example, the Extended Kalman Filter performs approximate Bayesian inference over k sets of temporal sub-weights characterizing the temporal sub-weights 102 as having a Gaussian distribution with mean \vec{μ}ₜ and covariance Σₜ. In this non-linear example, the Extended Kalman Filter characterizes the temporal sub-weights 102 as being distributed according to the same equation as above:

\vec{Z}ₜ|\vec{x}_{<t},y_{<t}˜ [symbol] (\vec{μ}ₜ,Σₜ)

During application of the Extended Kalman Filter, a local linear approximation, \tilde{f}, is computed following:

f(\vec{x}ₜ,\vec{Z}ₜ)≈\tilde{f}(\vec{x}ₜ,\vec{Z}ₜ)=f(\vec{x}ₜ,\vec{μ}ₜ)+J_{f,\vec{μ}}_{ₜ}(\vec{Z}ₜ−\vec{μ}ₜ)

Where J_{f,\vec{μ}}_{ₜ} is the Jacobian of f with respect to \vec{Z}ₜ evaluated at \vec{μ}ₜ and is a l×nk matrix.

An l×l conditional outcome variance matrix, R can be defined via the relation:

$${R}_{i , j} = \{ \begin{matrix}{\hat{y}}_{i} ( 1 - {\hat{y}}_{i} ) , i = j \\ - {\hat{y}}_{i} \hat{{y}_{j}} , i \neq j\end{matrix}$$

The non-linear Extended Kalman Filter performs the updates:

\vec{μ}ₜ₊₁+D(\vec{μ}ₜ+ΣₜJ_{f,\vec{μ}}_{ₜ}^{T}(J_{f,\vec{μ}}_{ₜ}ΣₜJ_{f,\vec{μ}}_{ₜ}^{T}+R)⁻¹(\vec{T}_{y,t}−ŷₜ))

Σₜ₊₁=D(Σₜ−ΣₜJ_{f,\vec{μ}}_{ₜ}^{T}(J_{f,\vec{μ}}_{ₜ}ΣₜJ_{f,\vec{μ}}_{ₜ}^{T}+R)⁻¹J_{f,\vec{μ}}_{ₜ}Σₜ)⁻¹D+N

As in the previous example, the system 100 stores the updated \vec{μ}ₜ₊₁ (i.e., the mean of the distribution characterizing the temporal sub-weights) as the current temporal sub-weights 102 and the updated Σₜ₊₁ (i.e., the covariance of the distribution characterizing the temporal sub-weights, estimating a joint uncertainty between the temporal sub-weights) as the current sub-weight statistics 204.

To improve computational efficiency, the temporal filter model 202 can be any of a variety of variational approximations of a Kalman Filter or of an Extended Kalman Filter. As an example, the system 100 can employ a variational approximation that the covariance matrix of the Kalman Filter or Extended Kalman Filter is constrained to be a diagonal covariance matrix. In these diagonal covariance variational approximations, an nk dimensional variance vector, \vec{σ}ₜ, is updated and stored rather than the full covariance matrix, Σₜ.

As one example, the linear Kalman Filter above utilizing this diagonal covariance variational approximation performs the variance update:

$${σ}_{t + 1 , [ i j ]}^{2} = \frac{{( {σ}_{t , [ i j ]}^{2} {e}^{- \frac{1}{{τ}_{i}}} + 4 {ρ}^{2} sin h \frac{1}{{τ}_{i}} )}^{2} Ω}{( {σ}_{t , [ i j ]}^{2} + 4 {e}^{\frac{1}{{τ}_{i}}} {ρ}^{2} sin h \frac{1}{{τ}_{i}} ) Ω + {x}_{t , j}^{2} {σ}_{t , [ i j ]}^{4}}$$

Where Ω is defined via:

$$Ω = {\sum }_{i , j} \frac{4 {ρ}^{2} {x}_{t , j}^{2} {σ}_{t , [ i j ]}^{2} sin h \frac{1}{{τ}_{i}}}{{σ}_{t , [ ij ]}^{2} {e}^{- \frac{1}{{τ}_{i}}} + 4 {ρ}^{2} sin h \frac{1}{{τ}_{i}}}$$

An nk dimensional learning rate vector, \vec{α}, can be defined via:

$${α}_{[ i j ]} = \frac{{e}^{- \frac{1}{{τ}_{i}}} {σ}_{t , [ i j ]}^{2}}{{( {\vec{x}}_{r}^{T} {\vec{σ}}_{r} )}^{2}}$$

The linear Kalman Filter utilizing this diagonal covariance variational approximation performs the mean update:

$${μ}_{t + 1 , [ i j ]} = {e}^{- \frac{1}{{τ}_{i}}} {μ}_{t , [ i j ]} - {α}_{[ i j ]} {x}_{t , j} ( {\hat{y}}_{t} - {y}_{t} )$$

As in the previous examples, the system 100 stores the updated \vec{μ}ₜ₊₁ (i.e., the mean of the distribution characterizing the temporal sub-weights) as the current temporal sub-weights 102 and the updated Σₜ₊₁ (i.e., the covariance of the distribution characterizing the temporal sub-weights, estimating a joint uncertainty between the temporal sub-weights) as the current sub-weight statistics 204.

As another example, the non-linear Extended Kalman Filter above utilizing this diagonal covariance variational approximation performs the variance updates:

$${σ}_{r + 1 , [ i j ]}^{2} = \frac{{D}_{[ i j ] , [ i j ]} {σ}_{t , [ ij ]}^{2}}{{{σ}_{t , [ i j ]}^{2} ( {( {J}_{f , {\vec{μ}}_{t}}^{T} {R}^{- 1} {J}_{f , {\vec{μ}}_{t}} )}_{[ i j ] , [ i j ]} + 1 )}^{- 1}}$$

$${μ}_{t + 1 , [ ij ]} = {e}^{- \frac{1}{{τ}_{i}}} {μ}_{t , [ i j ]} - {e}^{- \frac{1}{{τ}_{i}}} \frac{{D}_{[ i j ] , [ ij ]} {{σ}_{t , [ ij ]}^{2} ( {J}_{f {\vec{μ}}_{t}}^{T} {R}^{- 1} ( {\vec{T}}_{y , t} - {\hat{y}}_{t} ) )}_{[ i j ]}}{{{σ}_{t , [ ij ]}^{2} ( {( {J}_{f , {\vec{μ}}_{t}}^{T} {R}^{- 1} {J}_{f , {\vec{μ}}_{t}} )}_{[ i j ] , [ ij ]} + 1 )}^{- 1}}$$

As in the previous examples, the system 100 stores the updated \vec{μ}ₜ₊₁ (i.e., the mean of the distribution characterizing the temporal sub-weights) as the current temporal sub-weights 102 and the updated Σₜ₊₁ (i.e., the covariance of the distribution characterizing the temporal sub-weights, estimating a joint uncertainty between the temporal sub-weights) as the current sub-weight statistics 204.

It should be noted that these example diagonal covariance variational approximations store, update, and process the nk dimensional vector \vec{σ}ₜ stored rather than the nk×nk dimensional covariance matrix, Σₜ. Additionally, these diagonal covariance variational approximations avoid matrix inversions, which are particularly costly calculations.

As another example, the system 100 can employ a variational approximation constraining the covariance matrix of the Kalman Filter or Extended Kalman Filter to be a composition of a diagonal matrix with a low-rank matrix, avoiding the computation of matrix inversions. As another example, the system 100 can employ a variational approximation constraining the covariance matrix of the Kalman Filter or Extended Kalman Filter to be a Kronecker product of multiple matrices, each having dimensions smaller than the nk×nk dimensional covariance matrix, significantly reducing the sizes of the inverted matrices.

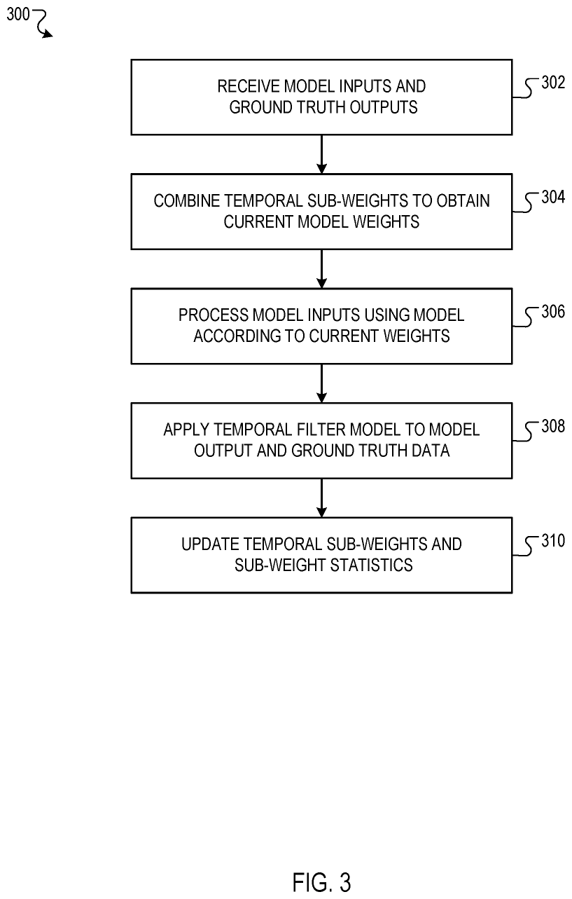

FIG. 3 is a flow diagram of an example process for online model training. For convenience, the process 300 will be described as being performed by a system of one or more computers located in one or more locations. For example, an online learning system, e.g., the online learning system 100 of FIG. 1, appropriately programmed in accordance with this specification, can perform the process 300.

The system receives model inputs and ground truth outputs (302). The system can receive the model inputs and ground truth data by any of a variety of methods. For example, the system can receive model inputs and ground truth data stored in memory. As another example, the system 100 can receive values for the model inputs and the ground truth outputs at each time step from one or more sensors that measure the model inputs and the ground truth outputs.

The system includes a machine learning model that uses a set of model weights to predict the ground truth outputs from the model inputs. The system combines currently stored temporal sub-weights to obtain the current model weights (304).

The system processes the model inputs using the machine learning model according to the current model weights to obtain output model predictions (306).

The system includes a temporal filter model that can determine updates for the temporal sub-weights based on the model predictions, the ground truth data, the current temporal sub-weights, and currently stored statistics for the temporal statistics. The system uses the temporal filter model to process the model predictions and the ground truth data to determine updates for the temporal sub-weights and sub-weight statistics (308).

The system updates the current temporal sub-weights and the current sub-weight statistics (310), e.g., using one of the techniques described above with reference to FIG. 2.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method implemented by one or more computers, comprising:
maintaining weight data for a machine learning model having a plurality of weights, wherein the machine learning model is configured to receive a model input and to process the model input in accordance with the weights to generate a model output for the model input, the weight data specifying:
for each of the plurality of weights, a plurality of sub-weights, and
covariance data that estimates the joint uncertainty between the sub-weights for the plurality of weights;
at each of the plurality of time steps:
receiving one or more model inputs;
processing each of the one or more model inputs using the plurality of sub-weights in the weight data to generate a respective model output for the model input;
receiving a respective ground truth output for each of the one or more model inputs; and
performing online learning by updating the plurality of sub-weights and the covariance data in the weight data using the respective ground truth outputs for the one or more model inputs.

2. The method of claim 1, wherein processing each of the one or more model inputs using the plurality of sub-weights in the weight data to generate a respective model output for the model input comprises:
for each weight, summing the sub-weights for the weight to generate a combined weight; and
processing each of the one or more model inputs in accordance with the combined weights to generate the respective model output for the model input.

3. The method of claim 1 wherein the machine learning model is a linear model and wherein performing online learning by updating the plurality of sub-weights and the covariance data in the weight data using the respective ground truth outputs for the one or more model inputs comprises:
updating the sub-weights and the covariance data using a Kalman Filter (KF) update.

4. The method of claim 1, wherein the machine learning model is a non-linear model and wherein performing online learning by updating the plurality of sub-weights and the covariance data in the weight data using the respective ground truth outputs for the one or more model inputs comprises:
updating the sub-weights and the covariance data by using a local linear approximation of the model for each of the model inputs as input to a Kalman Filter (KF) update.

5. The method of claim 4, wherein updating the sub-weights and the covariance data by using a local linear approximation of the model as input to a Kalman Filter (KF) update comprises:
using a local linear approximation of the model for each of the model inputs and, for each of the model inputs, a variance of the ground truth output for the model input conditioned on the model output for the model input as input to a Kalman Filter update.

6. The method of claim 1, wherein the covariance data is an approximation of a covariance matrix of the sub-weights that is constrained to be diagonal.

7. The method of claim 1, wherein performing online learning by updating the plurality of sub-weights and the covariance data in the weight data using the respective ground truth outputs for the one or more model inputs comprises:
updating the sub-weights and covariance data using a variational approximation of a Kalman Filter model or an Extended Kalman Filter model.

8. A system, comprising:
one or more computers; and
one or more storage devices communicatively coupled to the one or more computers, wherein the one or more storage devices store instructions that, when executed by the one or more computers, cause the one or more computers to perform operations, the operations comprising:
maintaining weight data for a machine learning model having a plurality of weights, wherein the machine learning model is configured to receive a model input and to process the model input in accordance with the weights to generate a model output for the model input, the weight data specifying:
for each of the plurality of weights, a plurality of sub-weights, and
covariance data that estimates the joint uncertainty between the sub-weights for the plurality of weights;
at each of the plurality of time steps:
receiving one or more model inputs;
processing each of the one or more model inputs using the plurality of sub-weights in the weight data to generate a respective model output for the model input;
receiving a respective ground truth output for each of the one or more model inputs; and
performing online learning by updating the plurality of sub-weights and the covariance data in the weight data using the respective ground truth outputs for the one or more model inputs.

9. The system of claim 8, wherein processing each of the one or more model inputs using the plurality of sub-weights in the weight data to generate a respective model output for the model input comprises:
for each weight, summing the sub-weights for the weight to generate a combined weight; and
processing each of the one or more model inputs in accordance with the combined weights to generate the respective model output for the model input.

10. The system of claim 8 wherein the machine learning model is a linear model and wherein performing online learning by updating the plurality of sub-weights and the covariance data in the weight data using the respective ground truth outputs for the one or more model inputs comprises:
updating the sub-weights and the covariance data using a Kalman Filter (KF) update.

11. The system of claim 8, wherein the machine learning model is a non-linear model and wherein performing online learning by updating the plurality of sub-weights and the covariance data in the weight data using the respective ground truth outputs for the one or more model inputs comprises:
updating the sub-weights and the covariance data by using a local linear approximation of the model for each of the model inputs as input to a Kalman Filter (KF) update.

12. The system of claim 11, wherein updating the sub-weights and the covariance data by using a local linear approximation of the model as input to a Kalman Filter (KF) update comprises:
using a local linear approximation of the model for each of the model inputs and, for each of the model inputs, a variance of the ground truth output for the model input conditioned on the model output for the model input as input to a Kalman Filter update.

13. The system of claim 8, wherein the covariance data is an approximation of a covariance matrix of the sub-weights that is constrained to be diagonal.

14. The system of claim 8, wherein performing online learning by updating the plurality of sub-weights and the covariance data in the weight data using the respective ground truth outputs for the one or more model inputs comprises:
updating the sub-weights and covariance data using a variational approximation of a Kalman Filter model or an Extended Kalman Filter model.

15. One or more non-transitory computer storage media storing instructions that when executed by one or more computers cause the one or more computers to perform operations, the operations comprising:
maintaining weight data for a machine learning model having a plurality of weights, wherein the machine learning model is configured to receive a model input and to process the model input in accordance with the weights to generate a model output for the model input, the weight data specifying:
for each of the plurality of weights, a plurality of sub-weights, and
covariance data that estimates the joint uncertainty between the sub-weights for the plurality of weights;
at each of the plurality of time steps:
receiving one or more model inputs;
processing each of the one or more model inputs using the plurality of sub-weights in the weight data to generate a respective model output for the model input;
receiving a respective ground truth output for each of the one or more model inputs; and
performing online learning by updating the plurality of sub-weights and the covariance data in the weight data using the respective ground truth outputs for the one or more model inputs.

16. The non-transitory computer storage media of claim 15, wherein processing each of the one or more model inputs using the plurality of sub-weights in the weight data to generate a respective model output for the model input comprises:
for each weight, summing the sub-weights for the weight to generate a combined weight; and
processing each of the one or more model inputs in accordance with the combined weights to generate the respective model output for the model input.

17. The non-transitory computer storage media of claim 15 wherein the machine learning model is a linear model and wherein performing online learning by updating the plurality of sub-weights and the covariance data in the weight data using the respective ground truth outputs for the one or more model inputs comprises:
updating the sub-weights and the covariance data using a Kalman Filter (KF) update.

18. The non-transitory computer storage media of claim 15, wherein the machine learning model is a non-linear model and wherein performing online learning by updating the plurality of sub-weights and the covariance data in the weight data using the respective ground truth outputs for the one or more model inputs comprises:
updating the sub-weights and the covariance data by using a local linear approximation of the model for each of the model inputs as input to a Kalman Filter (KF) update.

19. The non-transitory computer storage media of claim 18, wherein updating the sub-weights and the covariance data by using a local linear approximation of the model as input to a Kalman Filter (KF) update comprises:
using a local linear approximation of the model for each of the model inputs and, for each of the model inputs, a variance of the ground truth output for the model input conditioned on the model output for the model input as input to a Kalman Filter update.

20. The non-transitory computer storage media of claim 15, wherein performing online learning by updating the plurality of sub-weights and the covariance data in the weight data using the respective ground truth outputs for the one or more model inputs comprises:
updating the sub-weights and covariance data using a variational approximation of a Kalman Filter model or an Extended Kalman Filter model.
